(19) United States
(12) Patent Application Publication
(10) Pub. No.: US 2003/0189655 A1
(43) Pub. Date: Oct. 9, 2003

(54) Method of adaptive noise smoothing/restoration in spatio-temporal domain and high-definition image capturing device thereof

(76) Inventors: In-Keon Lim, Seoul (KR); Moon-Gi Kang, Ko-Yang City (KR); Sung-Cheol Park, Seoul (KR)

Correspondence Address: Volentine Francos, Suite 150, 12200 Sunrise Valley Drive, Reston, VA, 20191, US

(21) Appl. No.: 10/344,477

(22) PCT Filed: Jun. 26, 2002
(86) PCT No.: PCT/KR02/01216

(30) Foreign Application Priority Data
Jun. 29, 2001 (KR) 2001-0038280

(51) Int. Cl. H04N 5/217

(52) U.S. Cl. 348/241

(57) ABSTRACT

The present invention discloses a noise-filtering method and thereby a high-resolution image restoring technique from a blurred color image captured under low-level illumination condition wherein the noise filtering is performed in temporal and spatial domain in a sequential manner.

### FIELD OF THE INVENTION

The present invention relates to a noise filtering and thereby high-definition image restoring technique from stained color images which have been captured under an environment of extremely how illumination.

More particularly, the present invention relates to an image processing technique to eliminate the color blurring and signal-dependent Poisson noise of the captured image occurring under the extremely low illumination while the edges and the detailed information of the captured image are preserved.

### BACKGROUND ART

In case when color images are captured either by a color CCD camera or by a digital video camera under an environment of extremely low illumination, the image quality of the captured image tends to be very poor because the energy density of the captured image is lowers than that of the background noise of the image-capturing device.

More frequently, the deterioration of the image quality of the captured image is experienced if the image capturing process is continued without additional lighting equipment provided.

To resolve the above-mentioned problem, it is suggested that a specially designed image capturing apparatus such as an IR (infrared)input device or a photo amplifier should be employed for the enhancement of the image quality.

The approach of using a high end image-capturing device, however, is not applicable to consumer electronics including a digital video recorder (DVR) because of the manufacturing cost of a unit.

Consequently, it is necessary to devise a software technique including the digital signal processing of the captured image that makes it possible to eliminate the signal-dependent noise and to restore the blurred color image from a practical perspective.

It is usual to observe the local color blurring that is totally different color from the vicinity of the captured image if the captured image is taken under an environment of low illumination.

The occurrence of the color blurring is mitigated under relatively bright illumination. However, when the light illumination is not sufficient, the problem of the color blurring becomes severe.

The color blurring results from the fact that each channel constituting the color filter array of the CCD sensor processes in a uniform manner irrespective of the different characteristics of each channel.

In other words, the signal processing without consideration of the intensity of illumination changes the relative ratio of the colors of each pixel and consequently causes a local color blurring.

In addition, the captured image under low illumination suffers from the signal-dependent Poisson noise in the intensity region as well as the aforementioned color blurring.

FIG. 1 is a schematic diagram illustrating the captured image the quality of which is degraded due to the noise under low-level illumination in accordance with the prior art.

Referring to FIG. 1, it showed be noted that the captured image looks brighter than what it showed be due to the automatic gain controller (AGC). Referring to FIG. 1 more carefully, we can observe the color blurring of red (R), blue (B), and green (G) all over the image. The Poisson noise in a pixel unit can also be observed at locations where there is no color blurring.

It is strongly required, however, to be able to recognize the facial features of a criminal recorder under low illumination at a 24-hour operated digital video recorder (DVR) for the security and surveillance system.

Moreover, the captured image that is stored at a twenty-four-hour DVR system should be compressed to efficiently reduce the size of the data file. For instance, if an image with a large amount of motion of moving objects is compressed according to MPEG standard, a storage space of approximately 200 MByte is needed for a digital video recorder.

Since the color blurring observed in the color image captured under low illumination may be considered as the movement of an object in a time frame, the efficiency of the MPEG compression will be inevitably poor.

As a consequence, it often happens that more than 400-600 MByte of storage region is consumed in order to store the monitored image on a deserted place captured under low illumination.

Since the color blurring in an image captured under low illumination randomly occurs at each time frame, it is regarded as a movement of an object during the MPEG compression and thereby causes the degradation of the compression rate.

As an approach for eliminating the aforementioned compound noise, a temporal filtering scheme has been proposed.

The temporal filtering scheme in accordance with the prior art, however, employs the concept of motion compensation. Therefore, it requires a large amount of calculation time (CPU intensive).

Since the temporal filtering scheme performs a filtering process with tracing the trajectory of a moving object at every time frame, the calculation time for the estimation of the trajectory becomes too enormous to be implemented in real time.

Recently, another temporal filtering method has been introduced, which is based upon the motion detection in an effort to mitigate the errors and burdens of calculation time for the compensation of motion.

This approach, however, still has a shortcoming in a sense that the vector characteristics of the color image has not been fully taken into account.

The noise filtering technique in a temporal domain according to the prior are relies on a scheme that the motion of an object in a color image is detected only in terms of the brightness.

Since the difference of the brightness between the neighboring objects is not sufficient under low illumination, the scheme of detecting the motion in terms of the brightness should have a technical limit for the application.

Furthermore, the prior art has a shortcoming in that the Poisson noise that is present in the intensity, region of an image can not be eliminated even if the color blurring can be efficiently eliminated in case the prior art is applied in a temporal domain.

Moreover, since the spatial filtering technique according to the prior art relies on a stationary model, it is difficult to preserve an edge of object in an image once the noise is eliminated.

In other words, in case when the spatial filtering is performed in order to eliminate the high-frequency noise, even the edge line of the boundary between two objects tends to be spread in milky white.

This is because of the fact that the edge line has a high-frequency component. In order to overcome the difficulties of the aforementioned shortcomings, the edge adaptive filtering technique can be utilized.

The edge adaptive filtering technique, however, has a shortcoming because it can not eliminate the color blurring.

Since the color blurring in a spatial domain has a large correlation between neighboring pixels, the color blurring, which is the noise in case of the filtering, is treated as neighboring pixels in the blurred region. As a consequence, the filtered image also includes a color blurring.

As an approach combining the temporal filtering scheme and the spatial filtering scheme, a spatio-temporal filtering technique has been introduced. The noise filtering technique in spatio-temporal domain is simply the extention of the spatial filtering technique in time domain.

Therefore, it has a shortcoming in that the color is not eliminated even if the motion and edge boundary is adaptively designed.

### DETALED DESCRIPTION OF THE INVENTON

It is an object of the invention to provide a method and an apparatus of efficiently eliminating a color blurring as well as a signal-dependent noise and restoring the blurred image even with preserving the boundary edges and details of the captured image under low illumination.

It is further an object of the present invention to provide a method and an apparatus of eliminating noise adaptive to motion and an apparatus of eliminating noise adaptive to motion and edge in saptio-temporal domain and restoring the blurred image under low illumination.

Yet it is another object of the present invention to provide a method and an apparatus of noise filtering and image restoration to enhance the data compression rate and the image quality due to the color blurring and signal dependent noise.

The present invention discloses a technique to eliminate the color blurring and the signal dependent noise of the image captured under low illumination, comprising steps of (a) sensing the degree of motion through calculating the difference in brightness and hue between the pixels constituting a frame under consideration and the pixels of a reference frame; (b) calculating a brightness weight-function from the calculated brightness difference in step (a) and thereafter estimating a hue weight-function from the calculated hue difference in step (a);

(c) performing a temporal filtering only for a predefined number of pixels wherein the degree of motion calculated at step (b) is less than a predefined threshold, on each of R, G, and B channels, respectively;

(d) transforming the RGB image into the YUV format;

(e) sensing the degree of edge sharpness through estimating the brightness difference between the central pixels constituting a frame of the image and a predefined number of neighboring pixels;

(f) calculating the brightness weight-function according to the degree of edge sharpness from the brightness difference between the central pixels and the neighboring pixels of step (d);

(g) calculating a local average and/or a local dispersion with the brightness weight function of the step (f) for utilizing only the pixels located on the same side with reference to the edge line rather than using the pixels of the opposite side that have less correlation with the central pixels;

(h) performing the LLMMSE filtering of the brightness components of the image with utilizing the local average and/or the local dispersion of the step (g); and

(i) transforming into RGB format through combining the brightness component that has experienced a spatial filtering at the step of (h) with the pre-step hue components before the spatial filtering step of (h).

### BRIEF DESCRIPTION OF THE DRAWINGS

Further feature of the present invention will become apparent from a detailed description of the specification taken in conjunction with the accompanying drawings of the preferred embodiment of the invention, which, however, should not be taken to be limitative to the invention, but are for explanation and understanding only.

In the drawing:

FIG. 1 is a schematic diagram illustrating au image of deteriorated quality due to the noise generated under low illumination according to the prior art.

FIG. 2 is a schematic diagram illustrating a method of eliminating the noise and restoring the image in spatio temporal domain in accordance with the present invention.

FIGS. 3A through 3B are schematic diagrams illustrating embodiments of the spatio-temporal noise elimination method in accordance with the present invention.

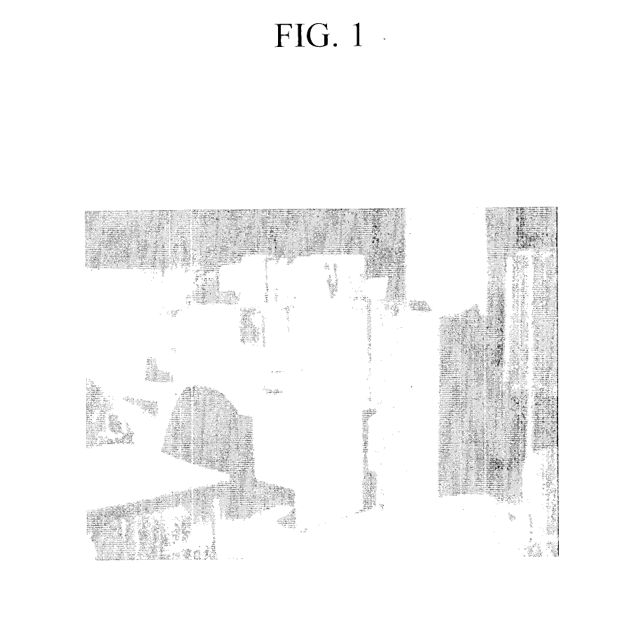

### DETAILED DESCRIPTION OF THE PREFERRED EMBODIMENT OF THE INVENTION

The present invention will be explained in detail with reference to the accompanying drawings.

The noise elimination method in accordance with the present invention can effectively remove the color blurring and signal-dependent noise simultaneously with preserving the edge sharpness and the details of the image ever under low illumination.

The present invention discloses a motion adaptive temporal filtering in time axis for eliminating the color blurring and an edge-preserving noise filtering for eliminating the Poisson noise.

The present invention has a feature in that the temporal filtering step is preceded to the spatio filtering in an effort to effectively eliminate the color blurring.

In addition, the noise elimination and restoring method in accordance with the present invention has a feature in that the color image filtering process is performed for each of R, G, and B channels while the prior art relies only on the intensity component for the color image filtering.

In other words, the present invention performs an independent filtering process for each of R, G, B channels in order to take both the intensity and the hue into account.

This is because the color blurring due to the deformation in the hue domain can not be removed if the filtered intensity component is combined with the nonfilteved hue component.

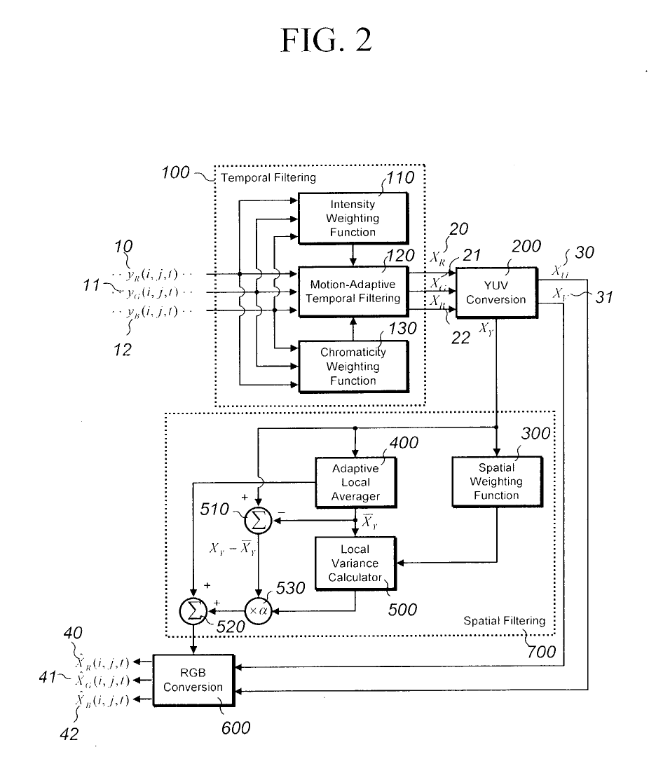

FIG. 2 is a schematic diagram illustrating an adaptive noise elimination and image restoring method in spatio-temporal domain in accordance with the present invention.

Referring to FIG. 2, the motion-adaptive temporal filtering 120 starts with the detection of motion among the frames as a pixel unit through vector order statistics of the color image.

Since the difference in brightness (i.e., light intensity) of an object is not sufficient for the detection of motion under low-level illumination, the prior art has a Shortcoming to be applied.

As a consequence, the present invention has a characteristic of taking both the intensity difference and the hue difference in order to detect the motion of an object with accuracy.

The detection of motion is performed both at intensity weight function block 100 and at chromaticity weighting function block 130 for temporal filtering 100 of FIG. 2.

$$\begin{matrix}{W}_{l} ( i , j , {t}_{2} ) = f ( \vert \frac{{Y}_{R} ( i , j , {t}_{1} ) + {Y}_{G} ( i , j , {t}_{1} ) + {Y}_{B} ( i , j , {t}_{1} )}{3} - \frac{{Y}_{R} ( i , j , {t}_{2} ) + {Y}_{G} ( i , j , {t}_{2} ) + {Y}_{B} ( i , j , {t}_{2} )}{3} \vert ) & ( 1 ) \\ {W}_{c} ( i , j , {t}_{2} ) = f ( {cos}^{- 1} ( \frac{y ( i , j , {t}_{1} ) \cdot y ( i , j , {t}_{2} )}{\vert y ( i , j , {t}_{1} ) \vert \vert y ( i , j , {t}_{2} ) \vert} ) ) & ( 2 )\end{matrix}$$

where, Wis the intensity weighting function, while W_{C} (is the chromaticity weighting function. Further, Y 10, 11, and 12 is the deteriorated vector color image.

Again, y_{R} 10 is the deteriorated R-channel image while y_{G} 11 and y_{B} 12 are the deteriorated G-channel and B-channel images, respectively.

Furthermore, t1 is a reference frame and t2 is another frame in temporal filtering. In addition, a function f(•) is a monotonically decreasing function with a functional value between 0 and 1.

As a preferred embodiment in accordance with the invention, f(•) has a small value in an interval between 0 and 1, and thereby a small weight is assigned if there exists relatively a large difference in intensity or chromaticity between a processed frame and a reference frame.

Furthermore, if there exists a large difference either in intensity or in chromaticity, f(•) becomes large and has a large weight.

As a preferred embodiment of a monotonically decreasing function f(•) in accordance with the invention, sigmoid function and on-off function can be utilized.

$$f ( x ) = ( 1 - \frac{1}{1 + {ⅇ}^{\frac{- ( x - T )}{τ}}} ) \qquad ( 1 )$$

where, T is a threshold which determines the degree of motion, and r is a coefficient that determines the slope of the function.

When r is made very small in equation 3, the small in equation 3, the function f(•) in accordance with the present invention becomes an on-off function. If x becomes greater than T, f(•) is zero, and vice versa.

The motion compensated spatio-temporal filtering technique in accordance with the prior art relies on a method of tracing the motion accurately and estimating the average along the trace of motion.

In the meanwhile, the present invention discloses a technique of sensing the motion of an object with weighting function 110 and 130, and performing R, G, B filtering at pixels wherein no motion has been detected.

Since the color blurring in spatial domain can be represented by additive white Gaussing noise as a pixel unit in temporal domain, it cam be eliminated with adaptive weighted averaging process as follows:

$$\begin{matrix}{X}_{R} ( i , j , {t}_{1} ) = {\sum }_{t = Ts}^{} {W}_{l} ( i , j , {t}_{2} ) {W}_{c} ( l , j , {t}_{2} ) {Y}_{R} ( i , j , {t}_{2} ) & ( 4 ) \\ {X}_{G} ( i , j , {t}_{1} ) = {\sum }_{t = Ts}^{} {W}_{l} ( i , j , {t}_{2} ) {W}_{c} ( l , j , {t}_{2} ) {Y}_{G} ( i , j , {t}_{2} ) & ( 5 ) \\ {X}_{B} ( i , j , {t}_{1} ) = {\sum }_{t = Ts}^{} {W}_{l} ( i , j , {t}_{2} ) {W}_{c} ( l , j , {t}_{2} ) {Y}_{B} ( i , j , {t}_{2} ) & ( 6 )\end{matrix}$$

where, T_{S} is a support in a temporal filter and can be 3˜9 frames as a preferred embodiment. The weighted filtering in accordance with the present invention effectively eliminates the noise due to motion and R, G, B channel filtering can eliminate the color blurring.

In the meanwhile, there still remains a signal dependent Poisson noise in the intensity domain despite the elimination of the color blurring at the step of temporal domain 100.

In order to remove the signal-dependent noise with preserving the edge sharpness of the image, an LLMMSE (local linear minimum mean square error) filter can be utilized in the intensity component (Y component) of the image.

The spatio filtering 700 in accordance with the present invention effectively eliminates the Poisson noise with preserving the edge sharpness through estimating a suitable local mean 400 and local variance 500 from the nonstationary characteristics of the image.

The above process can be represented by the estimation of local mean 400 and local variance 500 through the spatio weighting function 300 in spatio filtering block 700.

$$\begin{matrix}{\overline{X}}_{Y} ( i , j , t ) = \frac{1}{{\sum }_{k , l = {T}_{N}}^{} {W}_{l} ( i , j , t )} {\sum }_{k , l = {T}_{N}}^{} {W}_{l} ( \vert {X}_{Y} ( i , j , t ) - {X}_{Y} ( k , l , t ) \vert ) {X}_{Y} ( k , l , t ) & ( 7 ) \\ {V}_{X} ( i , j , t ) = \frac{1}{{\sum }_{k , l = {T}_{N}}^{} {W}_{l} ( i , j , t )} {\sum }_{k , l = {T}_{N}}^{} {{W}_{l} ( k , l , t ) [ {X}_{Y} ( k , l , t ) - {\overline{X}}_{Y} ( i , j , t ) ]}^{2} & ( 8 )\end{matrix}$$

where T_{N} is a support in spatio domain and Wis a weighting function in intensity domain for representing the edge sharpness.

The estimation of a local mean through the weighting function in accordance with the invention is performed with respect to the pixels of large correlation (the pixels located on the same side with reference to the edge) rather than those of little correlation (the pixels located on the opposite side with reference to the edge).

As a consequence it becomes possible to prevent the blurring effect in accordance with the present invention.

The estimation of the local variance in accordance with the resent invention makes it possible to preserve a fine resolution of the image more effectively. More specifically, the estimation of a local mean restores the image with a large degree of edges, while the estimation of a local variance through the weight function makes it possible to remove the noise at the edge region with keeping the fine region preserved in the image.

The LLMSE filter for the local statistics in accordance with the present invention can be designed such that it is suitable for the elimination of the Poisson noise.

\hat{X}_{Y}(i,t)=\tilde{X}_{Y}(i,j,t)+α(i,j,t)(X_{Y}(i,j,t)−\tilde{X}(i,j,t)) (9)

$$α ( i , j , t ) = max [ \frac{{V}_{X} ( i , j , t ) - \overline{X} ( i , j , t )}{{V}_{X} ( i , j , t )} , 0 ] \qquad ( 10 )$$

where, α takes the variance characteristics of the Poisson noise.

The intensity component of the image that has experienced the image that has experienced the spatio filtering in intensity domain is combined with the original chromaticity component prior to the spatio filtering, thereafter being transformed into RGB format.

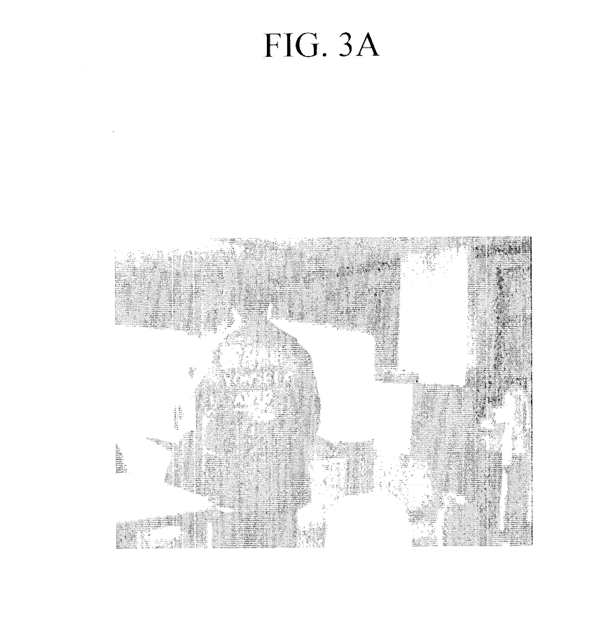

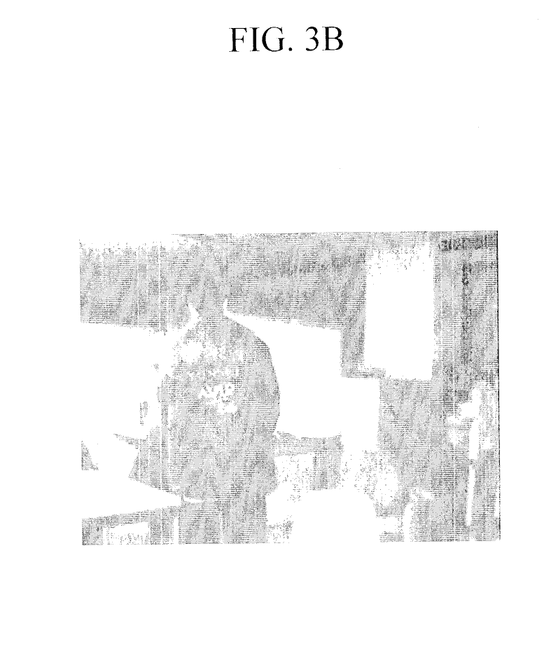

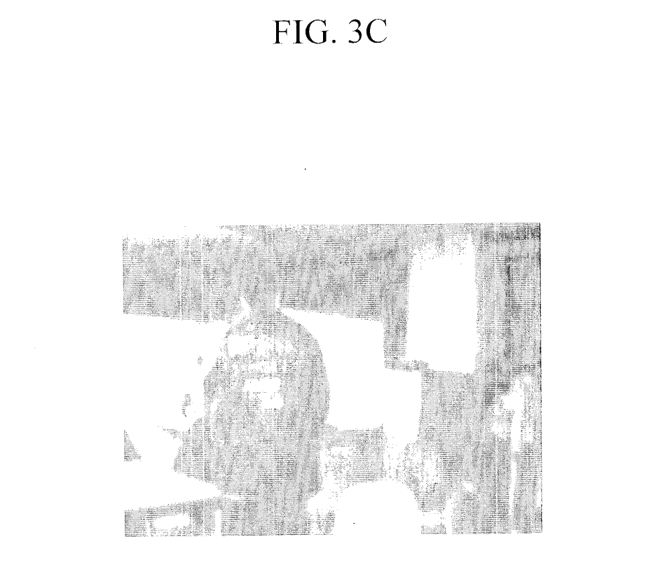

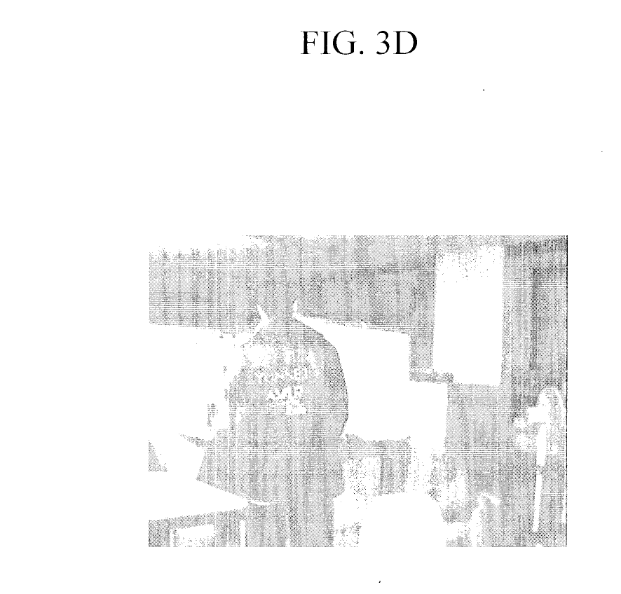

FIGS. 3A through 3D are schematic diagrams illustrating the preferred embodiments of the present invention in cornparision to the prior art.

Referring to FIG. 3A, a CCD camera-captured image is depicted for the illustration of the color blurring and Poisson noise.

FIG. 3B represents an exemplary image restored by eliminating the noise in accordance with the prior art. The color blurring has not been effectively removed because the prior art takes only the intensity component into account.

Furthermore, FIG. 3B reveals that the Poisson noise present in the intensity region has not been removed, either.

FIG. 3C is a picture of image which has been restored by eliminating the noise with the conventional spatio filtering technique.

Referring FIG. 3C, it is noted that the prior art can not effectively eliminate the color blurring even if the Poisson noise has been removed to some extent. Furthermore, FIG. 3C reveals that the edge boundary of the image has been seriously damaged.

FIG. 3D is a picture illustrating the image wherein the noise has been eliminated by the spatio-temporal filtering technique in accordance with the invention. FIG. 3D reveals that the color blurring and Poisson noise generated under low-level illumination have been effectively eliminated in accordance with the present invention.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

### INDUSTRIAL APPLICABILITY

The present invention makes it possible to restore the image captured under low-level illumination to the one of high image quality through eliminating the color blurring and the Poisson noise even with preserving the edge sharpness of an object.

Consequently, when the image processing technique in accordance with the present invention is applied to a digital video recorder (DVR), it is possible to overcome the shortcomings of the prior art such as the poor data compression rate due to the color blurring that is erroneously recognized as a motion of an object.

As a consequence, it is possible to tremendously reduce the data size of the image captured by a digital video recorder even under very low-level illumination.

Moreover, it is also possible to apply the noise-filtering technique to a general image-capturing device including a CMOS sensor and CCD camera, etc. with reduced price instead of the high-end products such as cameras equipped with IR sensors and/or photo amplifiers.

What is claimed is:

1. A method of eliminating color blurring and signal-dependent noise in the image captured under low-level illumination, comprising steps of:
(a) detecting the degree of motion of an object by calculating the difference in intensity (brightness) and chromaticity between the pixels of a frame under consideration and those of a reference frame;
(b) calculating an intensity weighting function according to the degree of motion that has been estimated from the difference in intensity between the pixels of a frame under consideration and those of a reference frame, and a chromaticity weighting function according to the degree of motion that has been estimated from the difference in chromaticity between the pixels of a frame under consideration and those of a reference frame;
(c) performing a temporal filtering only for pixels wherein the degree of motion that has been determined in step of (b) is less than a predefined threshold value for a predefined number of frames on each of R, G, B channels;
(d) transforming the image of RGB format into the one of YUV format;
(e) Sensing the edge sharpness from the calculation of the difference in chromaticity between each pixel (central pixel) and neighboring pixels around said central pixel for a frame under consideration;
(f) calculating an intensity weighting function according to the degree of edge sharpness that has been perceived from the difference in intensity between each pixel (central pixel) and neighboring pixels around said central pixel for a frame under consideration;
(g) calculating a local mean and/or variance form the pixels which are located only on the same side with respect to the edge boundary and have correlation greater than a threshold;
(f) performing an LLMMSE filtering on the intensity component of the image with said local mean and/or variance of the step (g); and
(i) combining the intensity component that has undergone the spatio filtering at step (h) with the chromaticity component prior to said spatio filtering to transform the processed image into RGB format.

2. The method as set forth in claim 1 wherein said intensity weighting function of step (b) comprises
$${W}_{l} ( i , j , {t}_{2} ) = f ( \vert \frac{{Y}_{R} ( i , j , {t}_{1} ) + {Y}_{G} ( i , j , {t}_{1} ) + {Y}_{B} ( i , j , {t}_{1} )}{3} - \frac{{Y}_{R} ( i , j , {t}_{2} ) + {Y}_{G} ( i , j , {t}_{2} ) + {Y}_{B} ( i , j , {t}_{2} )}{3} \vert )$$

3. The method as set forth in claim 1 wherein said chromaticity weighting function of step (b) comprises
$${W}_{c} ( i , j , {t}_{2} ) = f ( {cos}^{- 1} ( \frac{y ( i , j , {t}_{1} ) \cdot y ( i , j , {t}_{2} )}{\vert y ( i , j , {t}_{1} ) \vert \vert y ( i , j , {t}_{2} ) \vert} ) )$$

4. The method as set forth in claim 1 wherein either the intensity weighting function or the chromaticity weighting function comprises a monotonically decreasing function.

5. The method as set forth in claim 1 wherein either the intensity weighting function or the chromaticity weighting function comprises
$$f ( x ) = ( 1 - \frac{1}{1 + {ⅇ}^{\frac{- ( x - T )}{τ}}} )$$

6. The method as set forth in claim 1 wherein said temporal filtering of step (c) comprises a step of summing the products of the intensity weighting function and the chromaticity weighting function for a defined number of deteriorated frames (Y_{R}, Y_{G}, Y_{B}) to yield the restored signal (X_{R}, X_{G}, X_{B}) without the color blurring.

7. The method as set forth in claim 1 wherein said predefined number of frames are in the range of 3 to 9.

8. The method as set forth in claim 1 wherein said local mean of step (g) comprises
$${\overline{X}}_{Y} ( i , j , t ) = \frac{1}{{\sum }_{k , l = {T}_{N}}^{} {W}_{l} ( i , j , t )} {\sum }_{k , l = {T}_{N}}^{} {W}_{l} ( \vert {X}_{Y} ( i , j , t ) - {X}_{Y} ( k , l , t ) \vert ) {X}_{Y} ( k , l , t )$$

9. The method as set forth in claim 1 wherein said local variance of step (g) comprises
$${V}_{X} ( i , j , t ) = \frac{1}{{\sum }_{k , l = {T}_{N}}^{} {W}_{l} ( i , j , t )} {\sum }_{k , l = {T}_{N}}^{} {{W}_{l} ( k , l , t ) [ {X}_{Y} ( k , l , t ) - {\overline{X}}_{Y} ( i , j , t ) ]}^{2}$$

10. The method as set forth in claim 1 wherein said of performing an LLMMSE filtering comprises a step of performing an LLMMSE filtering with weighting factors according to the degree of edge sharpness from the relationship of
\hat{X}_{Y}(i,j,t)=\tilde{X}_{Y}(i,j,t)+α(i,j,t)(X_{Y}(i,j,t)−\tilde{X}_{Y}(i,j,t))
$$α ( i , j , t ) = max [ \frac{{V}_{X} ( i , j , t ) - \overline{X} ( i , j , t )}{{V}_{x} ( i , j , t )} , 0 ] .$$

11. An image processing apparatus for eliminating color blurring and signal-dependent noise of an image captured under low-level illumination, comprising:
an intensity processing module that calculates an intensity weighting function from the computation of the difference in intensity (brightness) between pixels of a frame under consideration and those of a reference frame;
a chromaticity processing module that calculates a chromaticity weighting function from the computation of the difference in chromaticity between pixels of a frame under consideration and those of a reference frame;
a temporal filter that computes the degree of motion for a predefined number of frames with basis on the intensity weighting function and the chromaticity weighting function and filters only a portion of pixels having the degree of motion less than a threshold value on each of R, G, B channels;
a first converter that converts the RCB signals from said temporal filter into YUN signals;
a spatio-weight processing module that calculates an intensity weighting function according to the degree of edge sharpness that has been determined from the difference in intensity between an arbitrary pixel comprising a frame from said first converter and neighboring pixels around said arbitrary pixel;
a spatio filter that calculates a local mean and/or a local variance of the pixels that are located on the same side with respect to the edge boundary and have correlation greater than a threshold, and thereby performs an LLMMSE filtering; and
a second converter that combines the intensity component from said spatio filter and the chromaticity component from said first converter to yield RGB signals.

12. The apparatus as set forth in claim 11 wherein either in hardware or by software program.

13. The apparatus as set forth in claim 11 wherein said apparatus in built in an image capturing device.

14. An image processing apparatus for eliminating noise mixed in image frame for moving pictures, comprising:
a temporal filter performing a motion-adaptive filtering in time domain through a multiplication of three terms and the successive summation of said multiplication for a predefined number of frames in order to take only the pixels of a frame having a degree of motion less than a threshold value wherein said three terms are an intensity weighting function representing a difference in intensity (Y signal) between frames, a chromaticity weighting function representing a difference in chromaticity (U, V signal) between frames, and a noise-mixed RGV signal; and
a spatio filter performing a edge-adaptive filtering in spatial domain through a spatial LLMMSE computation with a local mean and a local variance that take a intensity weighting function into account in order to take only the pixels of a frame having a degree of edge sharpness less than a threshold value wherein said intensity weighting function is generated by computing a difference in intensity between an arbitrary pixel (named as ‘a central pixel’)and neighboring pixels around said central pixel for a frame.

15. The apparatus as set forth in claim 13 wherein said temporal and spatio filters are implemented either in hardware or in software.

16. The apparatus as set forth in claim 13 wherein said apparatus is built in a CMOS sensor, a CCD camera, or in other image storing devices.

17. The apparatus as set forth in claim 13 wherein either said intensity weighting function or said chromaticity weighting function is a monotonically decreasing function such that the functional value becomes small when the difference either in intensity or in chromaticity between pixels is noticeable and vice versa, and thereby controls the computation such that pixels either with little motion in temporal domain or on the same side with respect to the edge boundary in spatial domain contribute in a significant manner.
